(19) United States
(12) Patent Application Publication
(10) Pub. No.: US 2017/0297812 A1
(43) Pub. Date: Oct. 19, 2017

(54) BEVERAGE PREPARATION DEVICE

(71) Applicant: Ramdeo MAHADEO, Bayside, NY (US)

(72) Inventor: Ramdeo MAHADEO, Bayside, NY (US)

(21) Appl. No.: 15/132,529

(22) Filed: Apr. 19, 2016

(51) Int. Cl. B65D 85/816; B65B 29/06; A23L 2/39

(52) U.S. Cl. CPC B65D 85/816; A23L 2/39; B65B 29/06

(57) ABSTRACT

A beverage preparation system for preparing beverages within a container by just adding water is provided. The beverage preparation system embodies an enclosure device forming a beverage admixture-filled enclosure with a permeable first membrane extending between first and second boundary elements. Attachment points may be disposed along the first and second membrane elements so as to enable formation of the beverage admixture-filled enclosure along the interior walls of the container by adhering the attachment points thereto. Alternatively, the enclosure device may provide a second membrane extending between the first and second boundary elements, forming a beverage admixture-filled reservoir so that the enclosure device may be received into and attached to any suitably sized pre-existing container. Whereby adding a suitable liquid to the container, the liquid permeates the first membrane so as to interact with the beverage admixture, resulting in a beverage mixture the user may drink from the container.

### BACKGROUND OF THE INVENTION

The present invention relates to beverage preparation systems and, more particularly, to a system for preparing beverages within a container by just adding water.

The preparation of fresh beverages can consume time and energy that, at least for on-the-go type personalities, could be better utilized for other things. And thus busy individuals would find a simpler, faster, and “less wasteful” beverage preparation method a boon.

As can be seen, there is a need for a system for preparing beverages within a container by just adding water.

### SUMMARY OF THE INVENTION

In one aspect of the present invention, an enclosure device includes a permeable first membrane extends between two opposing boundary elements so that the first membrane defines a hollow shape; and at least one attachment point disposed along each of the two opposing boundary elements, wherein a middle portion of the first membrane is concave relative to and into the hollow shape, and further including a second membrane extending between the two opposing boundary elements so as to define a reservoir between the first and second membranes, and wherein a beverage admixture is retained within the reservoir. In another aspect of the present invention, a method of preparing a beverage using the above-mentioned enclosure device, includes the steps of providing a container having an inner surface defining a cavity; sliding said enclosure device into the container; providing a beverage admixture; and urging the at least one attachment point of each of the two opposing boundary elements against the inner surface so as to define an enclosure filled with the beverage admixture, and further including the step of defining the enclosure so that a middle portion of the beverage admixture bulges into the hollow shape, and pouring a liquid into the hollow shape of the enclosure device.

In yet another aspect of the present invention, a beverage preparation system includes a container having an inner surface defining a cavity; an enclosure device having a permeable first membrane extends between two opposing boundary elements so that the first membrane defines a hollow shape; and at least one attachment point disposed along each of the two opposing boundary elements, wherein each attachment point adheres to the inner surface, defining an enclosure between the first membrane and the inner surface; wherein a beverage admixture is housed within the enclosure, and wherein a middle portion of the first membrane bulges into the hollow shape, and further including a liquid received within the cavity.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a section view of an exemplary embodiment of the present invention, taken along line 3-3 of FIG. 1;

FIG. 4 is a section view of an exemplary embodiment of the present invention, demonstrating an operative effect; and

FIG. 5 is a detail section view of an exemplary embodiment of the present invention, demonstrating a liquid permeating a first membrane, interacting with a beverage admixture so as to form a beverage mixture within a container.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a beverage preparation system for preparing beverages within a container by just adding water. The beverage preparation system may embody an enclosure device forming a beverage admixture-filled enclosure with a permeable first membrane extending between first and second boundary elements. Attachment points may be disposed along the first and second membrane elements so as to enable formation of the beverage admixture-filled enclosure along the interior walls of the container by adhering the attachment points thereto. Alternatively, the enclosure device may provide a second membrane extending between the first and second boundary elements, forming a beverage admixture-filled reservoir so that the enclosure device may be received into and attached to any suitably sized pre-existing container. Whereby adding a suitable liquid to the container, the liquid permeates the first membrane so as to interact with the beverage admixture, resulting in a beverage mixture the user may drink from the container.

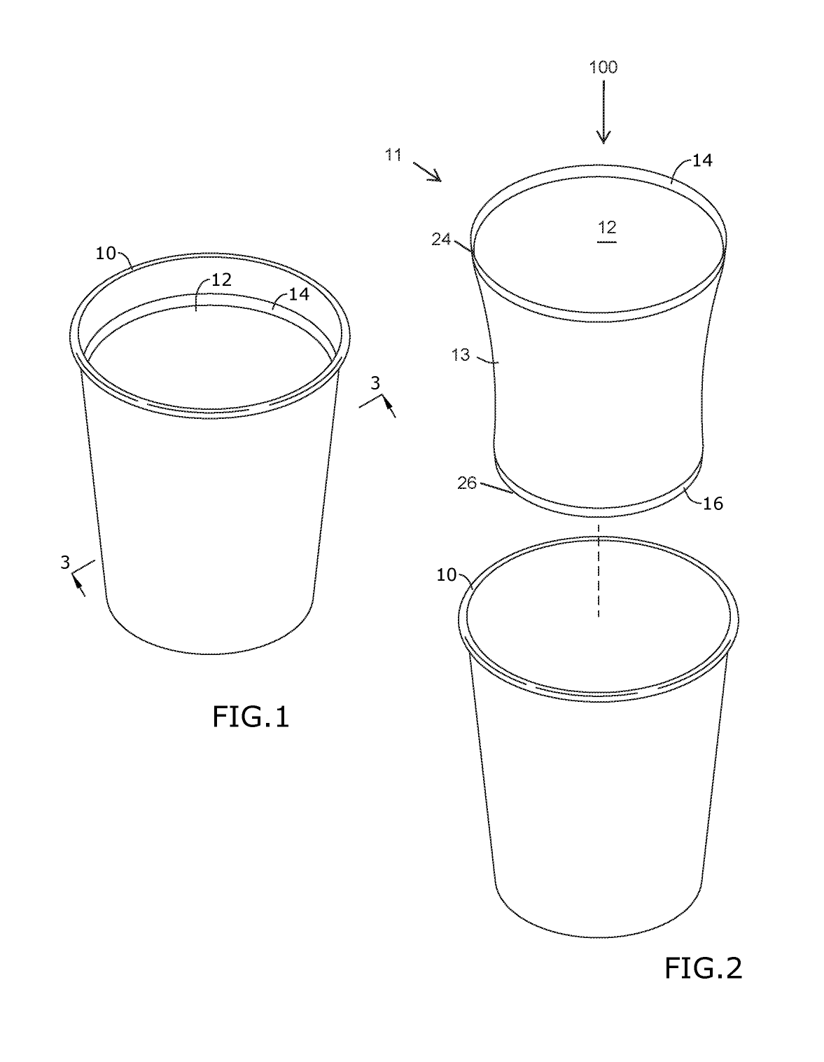

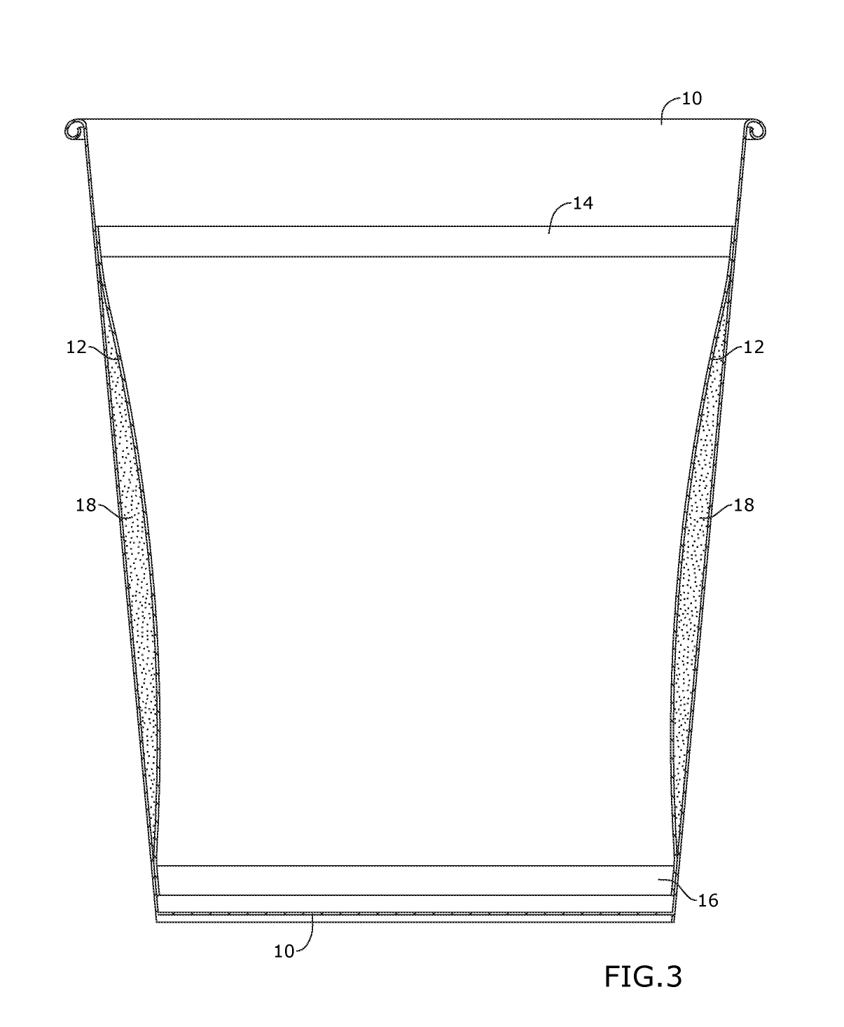

Referring to FIGS. 1 through 5, the present invention may include a beverage preparation system 100 for preparing beverages within a container 10 by just adding water. The beverage preparation system 100 may embody an enclosure device 11 defining an enclosure that houses a beverage admixture 18, and a method of using the same within the container 10.

The enclosure device 11 provides a first membrane 12 extending from a first boundary element 14 to a second boundary element 16, taking on a hollow shape for sliding in a cavity of the containers 10. If the container is cylindrical, then the over shape of the enclosure device 11 would be tubular forming a lumen. Though not shown specifically in the incorporated illustrations, the enclosure device 11 could be any hollow shape—oval, rectangular, and the like—so as to function in accordance with the present invention as described herein; for example, so as to slide into an oval, rectangular or the like shaped container 10.

The first membrane 12 may be made of water permeable material. The first membrane 12 of the enclosure device 11 may be concaved, curving into the hollow portion that it defines. The concave structure of the first membrane 12 enables defining a reservoir along the walls of the cavity of the container 10 that bulges with retained beverage admixture 18, wherein the first and second boundary elements 14, 16 pinch off the resulting bulge. Such a bulging configuration provides greater surface area of the beverage admixture 18-filled reservoir that would be accessible to a liquid 20 it may be submerged and/or steeped into.

A first and second boundary elements 14, 16 may provide attachment points, respectively. Each attachment point may be adapted to removably attach to a supporting surface, such as the inner surface of the container 10, after being slid therein. In certain embodiments, the enclosure device 11 may provide a second membrane 13 extending between the first and second boundary elements 14, 16, defining a reservoir sealed there between, wherein the beverage admixture 18 is retained within the reservoir. In such embodiments, the enclosure device 11 may be received into and attached to (via the same method describe above) any suitably sized pre-existing container 10.

The beverage admixture 18 may include any ingestible food or additive material, such as powder, that is at least in part water soluble, capable of saturating water, dissolving in water or otherwise interacting with a liquid containing water 20 so as the resulting mixture 30 of liquid 20 and the beverage admixture 18 is an ingestible beverage. For example, the beverage admixture 18 may be tea leaves, coffee grounds or the like, and the liquid 20 water.

The first and second membranes 12,13 and the first and second boundary elements 14, 16 may be adapted to take the shape of differently shaped containers 10 when the attachment points are adhered therein.

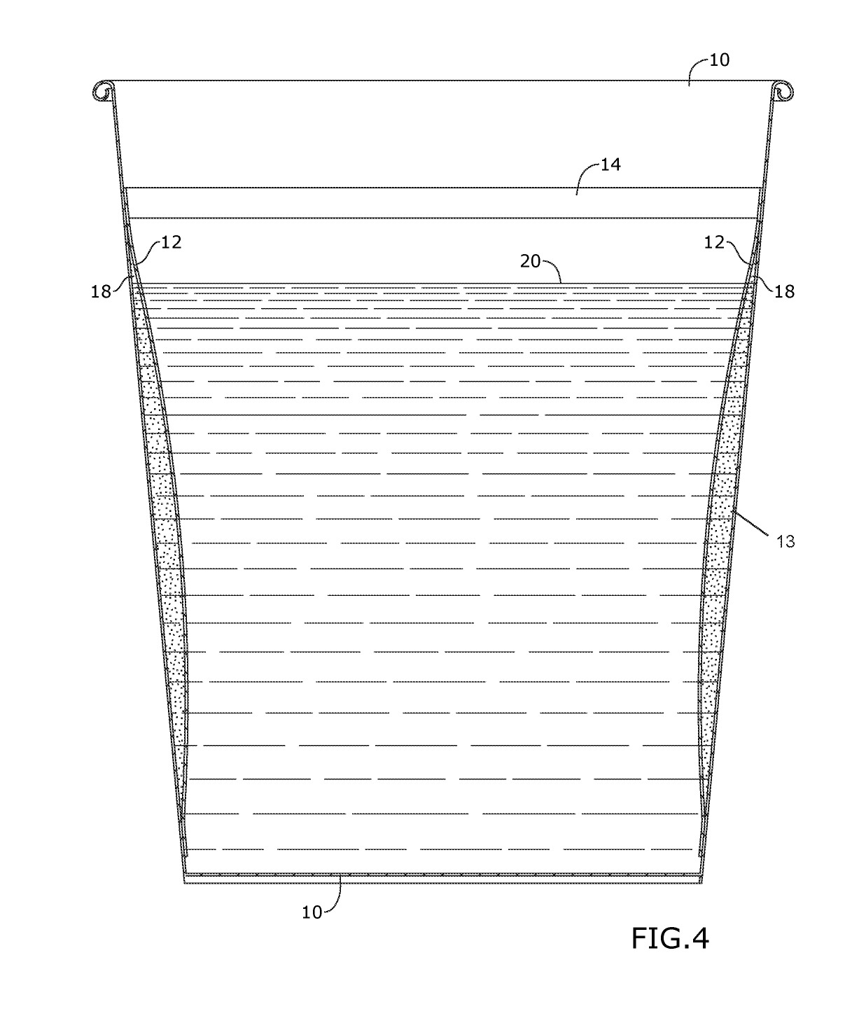

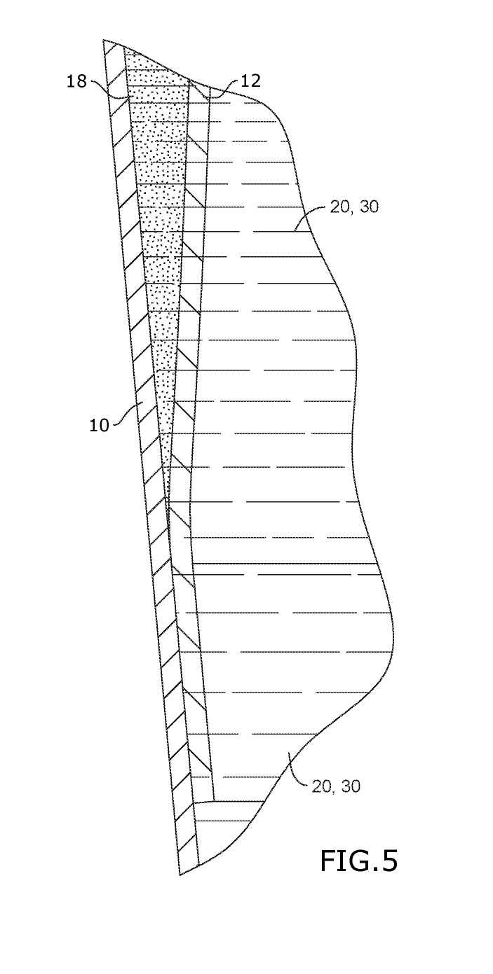

A method of using the present invention may include the following. The beverage preparation system 100 disclosed above may be provided. A thirsty user may slide into a suitable container 10, the enclosure device 11 housing a desired beverage admixture 18 within a reservoir defined between the first and second membrane 12, 13. In certain embodiments, the user may urge the attachment points of the boundary elements 14, 16 to removable adhere to the inner walls of the container 10 so that the enclosure device 11 does not move around during use, which includes the pouring of a liquid 20 into the container 10. Then the user may add the liquid 20 into the container 10, such as water, by pouring it through into the hollow defined by the enclosure device 11. The liquid 20 may be cooled or heated or any desirable temperature. The liquid 20 seeps through the permeable first membrane 12 so as to interact with the beverage admixture 18 housed thereby, resulting in the beverage mixture 30 within the container 10, as illustrated in FIGS. 4 and 5. As soon as desired, the user may enjoy the beverage mixture on the go, wherein the enclosure device 11 ensures that the beverage admixture 18 is not directly consumed, and wherein the attachment points keep the enclosure device 11 from sliding out of the container 10.

In certain embodiments, the first membrane 12-only enclosure device 11 is attached along the inner walls of the container 10 so as to form an enclosure between said inner walls and the first membrane 12, wherein the beverage admixture 18 is retained in between by the affixing of the attachment points of the first and second boundary elements 14, 16.

It should be understood, of course, that the foregoing relates to exemplary embodiments of the invention and that modifications may be made without departing from the spirit and scope of the invention as set forth in the following claims.

What is claimed is:

1. A device, comprising:
a permeable first membrane extends between two opposing boundary elements so that the first membrane defines a hollow shape; and
at least one attachment point disposed along each of the two opposing boundary elements.

2. The apparatus of claim 1, wherein a middle portion of the first membrane is concave relative to and into the hollow shape.

3. The apparatus of claim 2, further comprising a second membrane extending between the two opposing boundary elements so as to define a reservoir between the first and second membranes.

4. The apparatus of claim 3, further comprising a beverage admixture retained within the reservoir.

5. A method of preparing a beverage using the device of claim 1, comprising the steps of:
providing a container having an inner surface defining a cavity;
sliding said device into the container;
providing a beverage admixture; and
urging the at least one attachment point of each of the two opposing boundary elements against the inner surface so as to define an enclosure filled with the beverage admixture.

6. The method of claim 5, further comprising the step of defining the enclosure so that a middle portion of the beverage admixture bulges into the hollow shape.

7. The method of claim 6, further comprising the step of pouring a liquid into the hollow shape of the device.

8. A beverage preparation system, comprising:
a container having an inner surface defining a cavity;
an enclosure device comprising:
a permeable first membrane extends between two opposing boundary elements so that the first membrane defines a hollow shape; and
at least one attachment point disposed along each of the two opposing boundary elements, wherein each attachment point adheres to the inner surface, defining an enclosure between the first membrane and the inner surface; and
a beverage admixture housed within the enclosure.

9. The system of claim 6, wherein a middle portion of the first membrane bulges into the hollow shape.

10. The system of claim 7, further comprising a liquid received within the cavity.
